(19) United States
(12) Patent Application Publication
(10) Pub. No.: US 2024/0051165 A1
(43) Pub. Date: Feb. 15, 2024

(54) EXFOLIATING SHAVING DEVICE

(71) Applicant: BIC Violex Single Member S.A., Anoixi (GR)

(72) Inventor: Nikolaos CHRYSANTHAKOPOULOS, Anoixi (GR)

(73) Assignee: BIC Violex Single Member S.A., Anoixi (GR)

(21) Appl. No.: 18/363,391

(22) Filed: Aug. 1, 2023

(30) Foreign Application Priority Data
Aug. 12, 2022 (EP) 22190259.6

(51) Int. Cl. B26B 21/40

(52) U.S. Cl. CPC B26B 21/4012; B26B 21/4062; B26B 21/4056

(57) ABSTRACT

A shaving device including a head extending between a first end and a second end, the head being configured to support a blade, and the head including a base extending between the first end of the head and the second end of the head, the base including one or more magnetic projection extending from a surface of the base being configured to face a shaving surface, a handle being configured to support the head, and a magnetic field module included by one of the handle or the head, the magnetic field module being configured to be transitioned between an inactive state and an active state, wherein the magnetic field module is configured to interact with the one or more magnetic projection in the active state to move the one or more magnetic projection.

### CROSS-REFERENCE TO RELATED APPLICATIONS

This application claims priority from European patent application No. 22190259.6, filed on Aug. 12, 2022, the contents of which are hereby incorporated herein in their entirety by this reference.

### FIELD

The present disclosure relates generally to the field of skincare, and in particular to shaving. More specifically, the present disclosure relates to a shaving device configured to exfoliate skin of a user during shaving.

### BACKGROUND

Exfoliation of skin prior to and/or during shaving is a process that includes removing dead skin cells from an outermost layer of skin, such that the dead skin cells do not trap and/or partially obstruct hair, thereby diminishing a closeness of the shave. Additionally, dead skin cells may be cut and/or accumulate on blades of a shaving device during shaving, thereby dulling the blades and/or reducing an effectiveness of the blades. Accordingly, non-exfoliated skin reduces an overall performance of a shaving device.

A typical shaving device may include a handle and a replaceable shaving cartridge including configured to connect to the handle, without a feature configured to exfoliate the skin of a user. As such, the user must use separate exfoliating tools and/or treatments to mechanically and/or chemically exfoliate skin prior to and/or during shaving. Use of a separate exfoliating tool and/or treatment prior to and/or during shaving can be time consuming, costly, and/or require the user to perform specific exfoliating movements that are different from a typical shaving stroke.

It is desirable to provide a shaving device including a replaceable shaving cartridge having structures and/or relationships configured to exfoliate skin of a user without requiring a separate tool, treatment, and/or performance of a specific exfoliating action.

### SUMMARY

According to aspects of the present disclosure, a shaving device is provided. The shaving device includes a head extending between a first end and a second end, the head being configured to support a blade, and the head comprising a base extending between the first end of the head and the second end of the head, the base including one or more magnetic projection extending from a surface of the base being configured to face a shaving surface, a handle being configured to support the head, and a magnetic field module included by one of the handle or the head, the magnetic field module being configured to be transitioned between an inactive state and an active state, wherein the magnetic field module is configured to interact with the one or more magnetic projection in the active state to move the one or more magnetic projection.

According to aspects of the disclosure, the magnetic field module may be included within the handle of the shaving device.

According to aspects of the disclosure, the one or more magnetic projection may include a flexible stem extending from a root attached to the surface of the base of the head to a tip.

According to aspects of the disclosure, at least a portion of the one or more magnetic projection may include one or more ferromagnetic element suspended in an elastomeric matrix.

According to aspects of the disclosure, the one or more magnetic projection may have a mean diameter within a range of 0.001 mm and 0.5 mm.

According to aspects of the disclosure, the one or more magnetic projection may extend to a mean length within a range of 0.001 mm and 1 mm.

According to aspects of the disclosure, the one or more magnetic projection may be configured to move at a frequency of 10 Hz to 200 Hz.

According to aspects of the disclosure, the magnetic field module may be located at a mean distance within a range of 1 mm and 5 mm from the base of the head.

According to aspects of the disclosure, the magnetic field module may include one or more conductor configured to generate a magnetic field capable of interacting with the one or more magnetic projection.

According to aspects of the disclosure, the magnetic field module may include one or more field magnet configured to generate a magnetic field capable of interacting with the one or more magnetic projection.

According to aspects of the disclosure, a plurality of magnetic projections may extend from the base of the head.

According to aspects of the disclosure, the plurality of magnetic projections may be included in a plurality of sections of the base of the head, and one or more section of the plurality of sections may be included within a recess defined by the base of the head.

According to aspects of the disclosure, each magnetic projection may be located at a mean distance within a range of 0.05 mm and 2 mm from an adjacent magnetic projection.

According to aspects of the disclosure, the handle may include an actuator configured to transition the magnetic field module between the inactive state and the active state.

According to aspects of the disclosure, the actuator may be configured to be actuated manually by a user.

According to aspects of the disclosure, a method of exfoliating a surface of a user during a shaving action is provided. The method includes providing the shaving device according to any aspect disclosed herein, transitioning the magnetic field module from the inactive state to the active state, and pressing the one or more magnetic projection against the surface of the user.

In the manner described and according to aspects illustrated herein, the shaving device and the method are capable of exfoliating skin of a user without requiring a separate tool, treatment, and/or performance of a specific exfoliating action.

### BRIEF DESCRIPTION OF THE DRAWINGS

Aspects of an embodiment will be described in reference to the drawings, where like numerals reflect like elements:

FIG. 1 is a front perspective view of a shaving device according to aspects of the disclosure;

FIG. 2 is a partial side cross-sectional view of the shaving device according to FIG. 1, taken along line II of FIG. 1, depicting a plurality of projections of a head of the shaving device at rest;

FIG. 3 is a partial side cross-sectional view of the shaving device according to FIG. 1, showing an enlargement of aspect III of FIG. 2, depicting the plurality of projections of the head of the shaving device during movement;

FIG. 4A is a front perspective partial cross-sectional view of the shaving device according to FIG. 1, depicting a first example of a magnetic field module according to aspects of the disclosure; and

FIG. 4B is a front perspective partial cross-sectional view of the shaving device according to FIG. 1, depicting a second example of a magnetic field module according to aspects of the disclosure.

### DETAILED DESCRIPTION

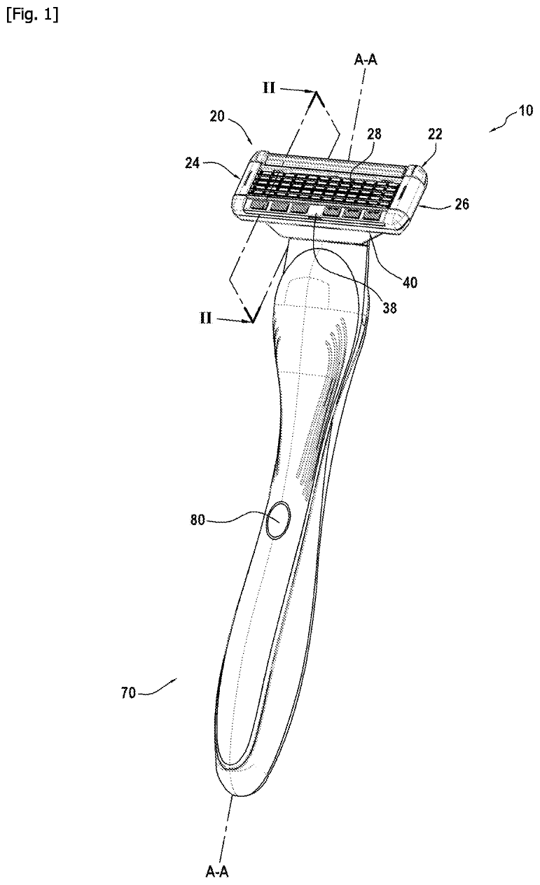

An embodiment of a shaving device and a method of exfoliating a surface of a user during performance of a shaving action according to aspects of the disclosure will now be described with reference to FIGS. 1-4B, wherein like numerals represent like parts, and will generally be referred to by the reference numeral 10. Although the shaving device 10 is described with reference to specific examples, it should be understood that modifications and changes may be made to these examples without going beyond the general scope as defined by the claims. In particular, individual characteristics of the various embodiments shown and/or mentioned herein may be combined in additional embodiments. Consequently, the description and the drawings should be considered in a sense that is illustrative rather than restrictive. The Figures, which are not necessarily to scale, depict illustrative aspects and are not intended to limit the scope of the disclosure. The illustrative aspects depicted are intended only as exemplary.

The term “exemplary” is used in the sense of “example,” rather than “ideal.” While aspects of the disclosure are amenable to various modifications and alternative forms, specifics thereof have been shown by way of example in the drawings and will be described in detail. It should be understood, however, that the intention is not to limit aspects of the disclosure to the particular embodiment(s) described. On the contrary, the intention of this disclosure is to cover all modifications, equivalents, and alternatives falling within the scope of the disclosure.

Various materials, methods of construction and methods of fastening will be discussed in the context of the disclosed embodiment(s). Those skilled in the art will recognize known substitutes for the materials, construction methods, and fastening methods, all of which are contemplated as compatible with the disclosed embodiment(s) and are intended to be encompassed by the appended claims.

As used in this disclosure and the appended claims, the singular forms “a,” “an,” and “the” include plural referents unless the content clearly dictates otherwise. As used in this disclosure and the appended claims, the term “or” is generally employed in its sense including “and/or” unless the content clearly dictates otherwise.

Throughout the description, including the claims, the terms “comprising a,” “including a,” and “having a” should be understood as being synonymous with “comprising one or more,” “including one or more,” and “having one or more” unless otherwise stated. In addition, any range set forth in the description, including the claims should be understood as including its end value(s) unless otherwise stated. Specific values for described elements should be understood to be within accepted manufacturing or industry tolerances known to one of skill in the art, and any use of the terms “substantially,” “approximately,” and “generally” should be understood to mean falling within such accepted tolerances.

When an element or feature is referred to herein as being “on,” “engaged to,” “connected to,” or “coupled to” another element or feature, it may be directly on, engaged, connected, or coupled to the other element or feature, or intervening elements or features may be present. In contrast, when an element or feature is referred to as being “directly on,” “directly engaged to,” “directly connected to,” or “directly coupled to” another element or feature, there may be no intervening elements or features present. Other words used to describe the relationship between elements or features should be interpreted in a like fashion (e.g., “between” versus “directly between,” “adjacent” versus “directly adjacent,” etc.).

Spatially relative terms, such as “top,” “bottom,” “middle,” “inner,” “outer,” “beneath,” “below,” “lower,” “above,” “upper,” and the like, may be used herein for ease of description to describe one element or feature's relationship to another element(s) or feature(s) as illustrated in the drawings. Spatially relative terms may be intended to encompass different orientations of a device in use or operation in addition to the orientation depicted in the drawings. For example, if the device in the drawings is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although the terms “first,” “second,” etc. may be used herein to describe various elements, components, regions, layers, sections, and/or parameters, these elements, components, regions, layers, sections, and/or parameters should not be limited by these terms. These terms are only used to distinguish one element, component, region, layer, or section from another region, layer, or section. Thus, a first element, component, region, layer, or section discussed herein could be termed a second element, component, region, layer, or section without departing from the teachings of the present disclosure.

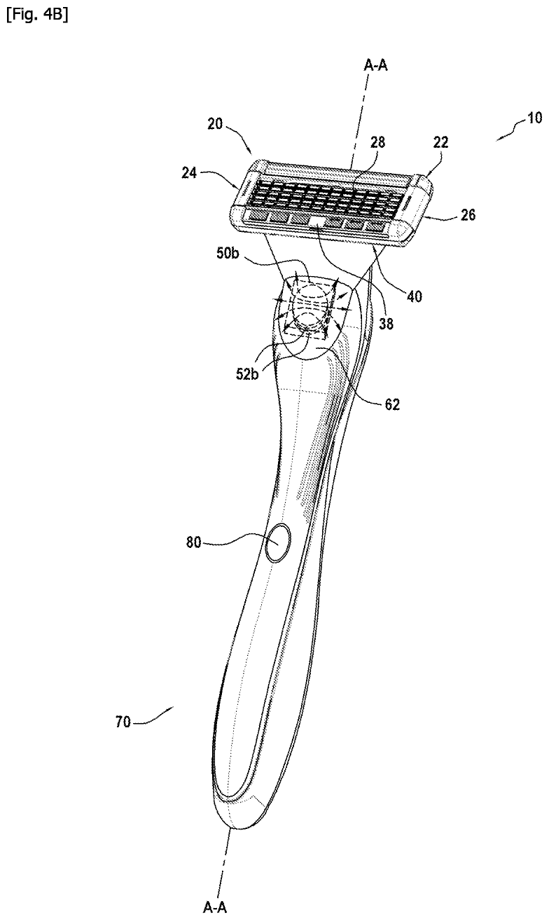

As shown in FIGS. 1 and 4A-4B, the shaving device 10 is bisected by an axis A-A. Additionally, the shaving device 10 includes a head (also referred to herein as a “replaceable shaving cartridge”) 20 and a handle 70. It is contemplated that the head 20 of the shaving device 10 is configured for shaving a body part (e.g. a face, arm, leg, and/or the like) of a user. Accordingly, the head 20 of the shaving device 10 may include a frame 22 extending between a first end 24 and a second end 26 of the of head 20, which is configured to support a plurality of blades 28 manufactured from sheet metal and/or the like extending across the head 20, between the first end 24 and the second end 26 of the head 20. Additionally, it is contemplated that the handle 70 of the shaving device 10 is configured to be held by a hand of the user. Accordingly, the handle 70 of the shaving device 10 may include an elongated, ergonomic shape corresponding to the hand of the user. Further, it is contemplated that the head 20 may be configured to be supported by and/or coupled to the handle 70 by way of a coupling mechanism (not shown) included on and/or forming part of one or more of the head 20 and/or the handle 70 of the shaving device 10.

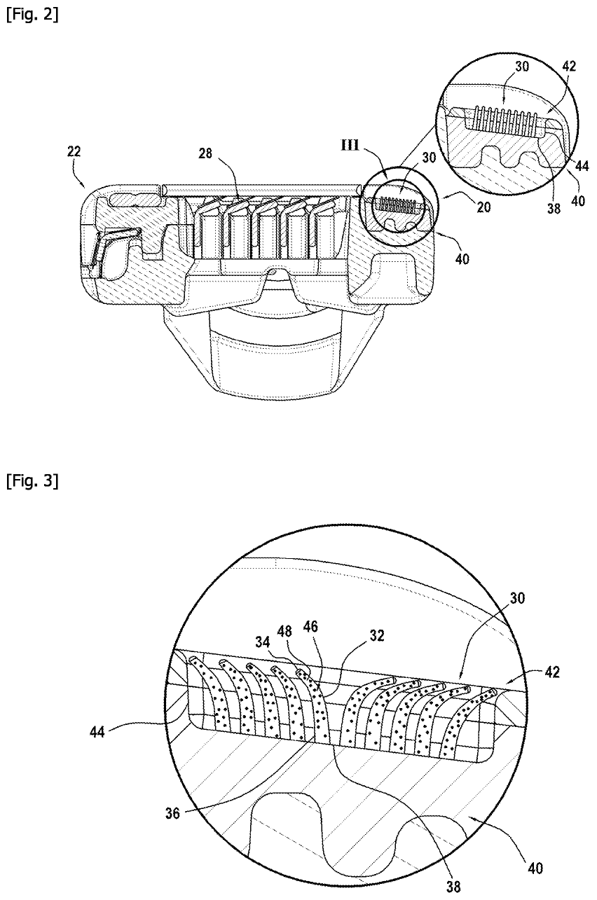

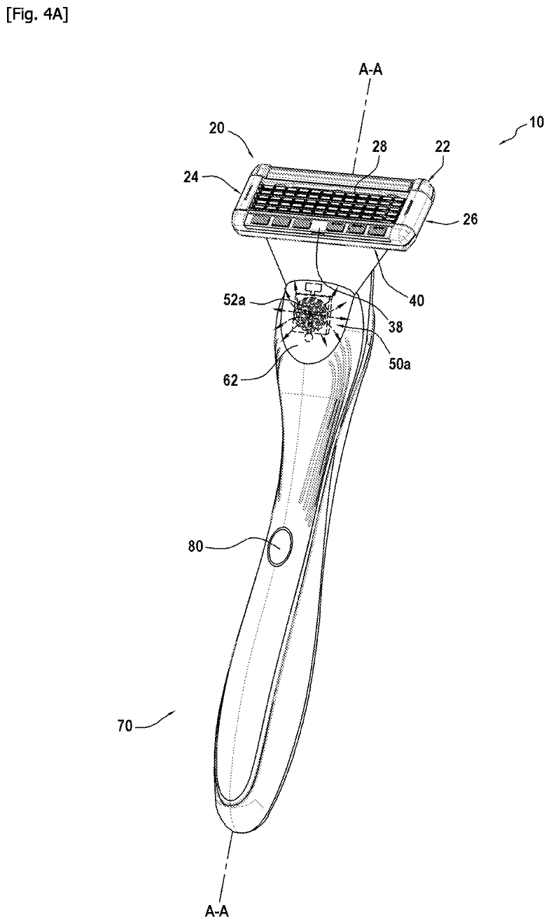

The shaving device 10 is configured to exfoliate skin of the user without requiring a separate tool, treatment, and/or performance of a specific exfoliating action. To this end, referring to FIGS. 2-3, the shaving device 10 includes one or more hair-like projection (also may be referred to herein as a “bristle”) 30 extending from the head 20 of the shaving device 10. In examples, the shaving device 10 may include a plurality of projections 30 extending from the head 20 of the shaving device 10; accordingly, the one or more projection 30 will be referred to hereafter as “the plurality of projections 30,” unless reference to one projection 30 of the plurality of projections 30 is otherwise necessary. In particular, the shaving device 10 may include between 1 and 500 projections 30 extending from the head 20. In examples, the plurality of projections 30 may have any shape that may be compatible with the shaving device 10, such as cylindrical, rod-like, irregular, and/or the like.

As shown in FIG. 3, a projection 30 of the plurality of projections 30 includes a stem 32 extending to a tip 34 from a root 36 that is attached to the head 20 of the shaving device 10. In examples, the plurality of projections 30 may have a mean diameter within a range of 0.001 mm to 0.5 mm. In particular, the plurality of projections 30 may have a mean diameter within a range of 0.02 mm to 0.2 mm. More in particular, the plurality of projections 30 may have a mean diameter of 0.1 mm. Additionally or alternatively, the plurality of projections 30 may extend to a mean length within a range of 0.001 mm to 1 mm. In particular, the plurality of projections 30 may extend to a mean length within a range of 0.3 mm to 1 mm. More in particular, the plurality of projections 30 may extend to a mean length of 0.7 mm. Accordingly, it is contemplated that the diameter and/or the length of the plurality of projections 30 may be the same, substantially the same, or different from each other. At least a portion of each projection 30 of the plurality of projections 30 is configured to come in contact with the skin of the user during a shaving action and/or stroke performed by the user, thereby exfoliating the skin of the user prior to and/or during contact between the skin of the user and the plurality of blades 28 of the shaving device 10. In particular, the tips 34 of the plurality of projections 30 and at least a portion of the stems 32 of the plurality of projections 30 are configured to come in contact with the skin of the user during a shaving action performed by the user to exfoliate the skin of the user prior to and/or during contact between the skin of the user and the plurality of blades 28 of the shaving device 10. To this end, the plurality of projections 30 are oriented at a position upstream of the plurality of blades 28 of the shaving device 10. It is contemplated that the terms “upstream” and “downstream” as referred to herein may be understood with reference to areas of possible contact between the head 20 of the shaving device 10 and the skin of the user, such that an upstream position on the head 20 of the shaving device 10 contacts the skin of the user before a downstream position on the head 20 of the shaving device 10 during a shaving action.

Referring to FIG. 3, the tips 34 of the plurality of projections 30 and at least a portion of the stems 32 of the plurality of projections 30 may be configured to be more flexible than the roots 36 of the plurality of projections 30, which may be configured to be more rigid than the tips 34 of the plurality of projections 30 and at least a portion of the stems 32 of the plurality of projections 30. In this manner, the plurality of projections 30 are configured for movement (discussed further below). In this manner, the plurality of projections 30 are configured to bend against the skin of the user, thereby providing a smoother, more ergonomic experience for the user.

In examples, the plurality of projections 30 may extend from a surface 38 of a base 40 included on and/or forming part of the frame 22 of the head 20 of the shaving device 10. As such, the roots 36 of the plurality of projections 30 are attached to the base 40 of the head 20. It is contemplated that the roots 36 of the plurality of projections 30 may be attached to the base 40 of the head 20 by any form of attachment that may be compatible with the shaving device 10, such as an adhesive attachment, interference fit attachment, and/or the like. In examples, the base 40 is oriented at a position upstream of the plurality of blades 28 of the head 20. In particular, the base 40 may be oriented at or adjacent to and/or form part of an upstream edge of the frame 22 of the head 20 of the shaving device 10. The base 40 extends perpendicular to or substantially perpendicular to the axis A-A of the shaving device 10. Additionally, the base 40 extends parallel to or substantially parallel to the plurality of blades 28 of the head 20.

It is contemplated that at least the base 40 of the frame 22 of the head 20 may have any shape that may be compatible with the shaving device 10, such as orthogonal, polygonal, rectangular, ovoid, and/or the like. Additionally or alternatively, at least the surface 38 of the base 40 of the frame 22 of the head 20 may have any form that may be compatible with the shaving device 10, such as flat, curved, beveled, and/or the like. Additionally or alternatively, at least the base 40 of the frame 22 of the head 20 may be made of any material that may be compatible with the shaving device 10, such as acrylonitrile butadiene styrene (i.e., ABS), polypropylene (i.e., PP), polystyrene (i.e., PS), and/or the like. In examples, a length of at least the base 40 of the frame 22 of the head 20 may be within a range of 5 mm to 40 mm. Additionally or alternatively, a width of at least the base 40 of the frame 22 of the head 20 may be within a range of 1 mm to 10 mm. Additionally or alternatively, a height of at least the base 40 of the frame 22 of the head 20 may be within a range of 0.001 mm to 1 mm. Additionally or alternatively, a thickness of at least the base 40 of the frame 22 of the head 20 may be within a range of 0.01 mm to 0.1 mm. In this manner, at least the base 40 of the frame 22 of the head 20 of the shaving device 10 may be configured to be sufficiently flexible to counteract a normal shaving force exerted by the user on the head 20 of the shaving device 10 to the skin of the user during performance of a shaving action, so as to allow the plurality of projections 30 to move between the head 20 and the skin of the user, thereby exfoliating the skin of the user prior to and/or during performance of a shaving action performed by the user. It is contemplated that a normal shaving force may be within a range of 0.3 N to 4 N.

In examples, the plurality of projections 30 may be included in one or more section 42 of the base 40 of the frame 22 of the head 20 that extends along the base 40. Within the one or more section 42 of the base 40, each projection 30 of the plurality of projections 30 may be located at a mean distance within a range of 0.05 mm and 2 mm from an adjacent projection 30 of the plurality of projections 30. In examples, it is contemplated that a distribution of the plurality of projections 30 within the one or more section 42 of the base 40 may be ordered or random. In particular, the plurality of projections 30 may be included in a plurality of sections 42 of the base 40 of the head 20. It is contemplated that each section 42 of the plurality of sections 42 may have a same or different size and/or shape. In examples, each section 42 of the plurality of sections 42 may be provided within a recess 44 defined by the base 40 of the head 20. In this manner, attachments between the roots 36 of the plurality of projections 30 are protected from an external environment. It is contemplated that the term “external” as referred to herein may be understood as any environment surrounding the shaving device 10. In examples, the plurality of sections 42 may be provided in the form of a pad provided on the surface 38 of the base 40. In this manner, it is contemplated that the attachment of the plurality of projections 30 to the base 40 may be facilitated and/or simplify manufacture of the shaving device 10. Additionally or alternatively, in this manner, it is contemplated that the attachment of the plurality of projections 30 to the base 40 may allow the plurality of projections 30 to be interchangeable and/or attached to any head 20.

As shown in FIG. 3, the plurality of projections 30 are configured for movement, so as to be capable of exfoliating the skin of the user independent of and/or in collaboration with a shaving action performed by the user. To this end, the plurality of projections 30 are configured to be magnetic and/or to generate a magnetic field and the shaving device 10 is configured to include a magnetic field module 50a, 50b (discussed further below) configured to generate a magnetic field capable of interacting with the plurality of projections 30 to move the plurality of projections 30. It is contemplated that the interaction between the magnetic field generated by the magnetic field module 50a, 50b and the plurality of projections 30 may be understood as an interaction between the magnetic field generated by the magnetic field module 50a, 50b and the magnetic field generated by the plurality of projections 30. To this end, at least a portion of each projection 30 of the plurality of projection 30 includes one or more ferromagnetic element (also may be referred to herein as a “ferromagnetic particle”) 46 suspended in an elastomeric matrix 48. In particular, at least the tip 34 of each projection 30 of the plurality of projections 30 and at least a portion of the stem 32 of each projection 30 of the plurality of projections 30 may include the elastomeric matrix 48, in which the one or more ferromagnetic element 46 is suspended. Further, each projection 30 of the plurality of projections 30 may include a plurality of ferromagnetic elements 46; accordingly, the one or more ferromagnetic element 46 will be referred to hereafter as “the plurality of ferromagnetic elements 46,” unless reference to one ferromagnetic element 46 of the plurality of ferromagnetic elements 46 is otherwise necessary.

In examples, the plurality of projections 30 may be made of any elastomeric material that may be compatible with the shaving device 10, such as a plastic, a rubber, a silicone, and/or the like. Additionally, in examples, the plurality of ferromagnetic elements 46 may be made in and/or of any ferromagnetic form and/or ferromagnetic material that may be compatible with the shaving device 10, such as ferromagnetic particles (e.g. iron pentacarbonyl, iron (II) chloride, iron(III) chloride, and/or the like), polymer-coated ferromagnetic particles, ferromagnetic nanoparticle chains, metal micropillars, metal-coated polymer, and/or the like. Further, the plurality of ferromagnetic elements 46 may have a mean diameter within a range of 0.00001 mm to 0.1 mm. In examples, the plurality of ferromagnetic elements 46 may have any shape that may be compatible with the shaving device 10, such as spherical, cylindrical, irregular, and/or the like. In examples, the plurality of projections 30 may be configured to move at a frequency within a range of 10 Hz to 200 Hz. Referring to FIG. 2, at rest, at least a portion of each projection 30 of the plurality of projections 30 may be oriented at an angle within a range of 75 degrees to 100 degrees. Additionally or alternatively, referring to FIG. 3, during movement, at least a portion of each projection 30 of the plurality of projections 30 may be oriented at an angle within a range of 20 degrees to 160 degrees. In this manner, the plurality of projections 30 are configured to interact with a magnetic field generated by the magnetic field module 50a, 50b, so as to be moved by the magnetic field module 50a, 50b, thereby exfoliating the skin of the user prior to and/or during performance of a shaving stroke by the user.

As shown in FIGS. 4A-4B, the shaving device 10 is configured to include the magnetic field module 50a, 50b configured to interact with the plurality of projections 30 of the head 20 to move the plurality of projections 30. To this end, one or more of the head 20 or the handle 70 of the shaving device 10 is configured to include the magnetic field module 50a, 50b. In particular, the handle 70 and/or an extension thereof is configured to include the magnetic field module 50a, 50b. As such, the handle 70 may define a cavity 62 configured to receive and support the magnetic field module 50a, 50b within the handle 70. In examples, the magnetic field module 50a, 50b may be arranged in an orientation that extends parallel or substantially parallel to the base 40 of the frame 22 of the head 20. Additionally or alternatively, the magnetic field module 50a, 50b may be arranged at a mean distance within a range of 1 mm to 5 mm from the base 40 and/or the plurality of projections 30. Additionally or alternatively, is contemplated that the magnetic field module 50a, 50b may be on or within a pivoting mechanism (not shown) included by the handle 70, so that the magnetic field module 50a, 50b may follow a motion of the head 20 during a shaving stroke, thereby maintaining the distance between the magnetic field module 50a, 50b and the base 40 and/or the plurality of projections 30. In this manner, by including the magnetic field module 50a, 50b in the handle 70, within close range of the plurality of projections 30, all electronic components of the shaving device 10 are included in the handle 70, and not in the head 20, thereby allowing the head 20 to be replaceable and/or disposable.

Referring to FIGS. 4A-4B, the magnetic field module 50a, 50b is configured to be transitioned between an inactive state and an active state. In the inactive state, the magnetic field module 50a, 50b is not capable of generating a magnetic field. In the active state, the magnetic field module 50a, 50b is capable of generating a magnetic field. To this end, as shown in FIG. 4A, in a first example of a magnetic field module 50a, the magnetic field module 50a may include one or more conductor 52a configured to receive and carry electric current so as to generate a magnetic field (also may be referred to herein as an “electromagnetic field”) capable of interacting with the plurality of projections 30 in order to move the plurality of projections 30. In examples, the magnetic field module 50a may include a plurality of conductors 52a; accordingly, the one or more conductor 52a will be referred to hereafter as “the plurality of conductors 52a,” unless reference to one conductor 52a of the plurality of conductors 52a is otherwise necessary. In particular, the magnetic field module 50a may include 1 to 10 conductors 52a. In examples, each conductor 52a of the plurality of conductors 52a may be in the form of an electromagnetic micro-coil.

As shown in FIG. 4B, in a second example of a magnetic field module 50b, the magnetic field module 50b may include one or more field magnet 52b configured to generate the magnetic field capable of interacting with the plurality of projections 30 of the head 20 in order to move the plurality of projections 30. It is contemplated that the term “field magnet” as used herein may be understood to be a permanent magnet, an electromagnet, and/or the like. In examples, the magnetic field module 50b may include a plurality of field magnets 52b; accordingly, the one or more field magnet 52b will be referred to hereafter as “the plurality of field magnets 52b,” unless reference to one field magnet 52b of the plurality of field magnets 52b is otherwise necessary. In particular, the magnetic field module 50b may include 1 to 10 field magnets 52b. In examples, each field magnet 52b of the plurality of field magnets 52b may be in the form of a micromagnet.

It is contemplated that the plurality of field magnets 52b may be made of any ferromagnetic material that may be sufficiently strong and/or compatible with the shaving device 10, such as neodymium (NdFeB), samarium cobalt (SmCo), ferrite (also may be referred to herein as “ceramic”), alnico (aluminum (Al), nickel (Ni), and cobalt (Co)), and/or the like. Additionally or alternatively, the plurality of field magnets 52b may have any shape that may be compatible with the shaving device 10, such as disc-shaped, square-shaped, irregular, and/or the like. It is contemplated that the plurality of field magnets 52b may be configured to moved mechanically within the magnetic field module 50b, so as to vary a distance between the plurality of field magnets 52b and the plurality of projections 30, thereby varying a strength of the magnetic field and/or a direction of the magnetic field exerted on the plurality of projections 30 and, thus, moving the plurality of projections 30. To this end, the magnetic field module 50b may include a motorized mechanism (not shown) configured to support and/or move the plurality of field magnets 52b. The plurality of field magnets 52b may be moved via rotation and/or translation parallel or substantially parallel to the base 40 of the frame 22 of the head 20 and/or perpendicular or substantially perpendicular to the base 40.

In examples, the magnetic field generated by magnetic field module 50a, 50b may be configured to vary a strength of the magnetic field generated by the magnetic field module 50a, 50b. To this end, the magnetic field module 50a, 50b may operate according to instructions, such as that provided by an algorithm and/or the like, which are configured to vary the strength of the magnetic field exerted on the plurality of projections 30. Further, the shaving device 10 may include an electronic control unit (i.e., an ECU)(not shown), a printed circuit board (i.e. a PCB)(not shown), and/or the like that is configured to communicate with the magnetic field module 50a, 50b. In examples, a local magnetic field strength generated by the magnetic field module 50a, 50b and/or exerted on the plurality of projections 30 may be within a range of 5 mT and 50 mT. Additionally or alternatively, the plurality of conductors 52a and/or plurality of magnets 52b may be configured to be activated simultaneously, independently of each other, and/or serially at a pre-determined frequency. In examples, a frequency of activation and/or variation of the magnetic field generated by the magnetic field module 50a, 50b may be within a range of 10 Hz to 200 Hz. It is contemplated that the shaving device 10 may include an adjustment module (not shown) configured to communicate with the electronic control unit to prompt the electronic control unit to adjust a frequency of activation and/or variation of the magnetic field generated by the magnetic field module 50a, 50b and, thus, a speed and/or rate of exfoliation of the plurality of projections 30. The adjustment module may be in any form that may be compatible with the shaving device 10, such as one or more button, a slider, a rotatable knob, and/or the like included on the handle 70. In this manner, by varying the magnetic field exerted on the plurality of projections 30, the magnetic field module 50a, 50b and, thus, the shaving device 10, is capable of moving the plurality of projections 30 to exfoliate the skin of the user prior to and/or during contact between the skin of the user and the plurality of blades 28 of the shaving device 10.

In examples, the shaving device 10 may include a power source (not shown) configured to deliver power to the magnetic field module 50a, 50b, such that the magnetic field module 50a is capable of delivering electric current to the plurality of conductors 52a of the magnetic field module 50a or such that the magnetic field module 50b is capable of delivering electric power to the motorized mechanism of the magnetic field module 52b. It is contemplated that the shaving device may include any source of power that may be compatible with the shaving device 10, such as disposable batteries, rechargeable batteries, a wireless inductive charging module, and/or the like.

In examples, the shaving device 10 may include an actuator 80 configured to transition the magnetic field module 50a, 50b from the inactive state to the active state and/or to transition the magnetic field module 50a, 50b from the active state to the inactive state. It is contemplated that the actuator 80 is configured to communicate with the electronic control unit to prompt the electronic control unit to transition the magnetic field module 50a, 50b from the inactive state to the active state and/or to transition the magnetic field module 50a, 50b from the active state to the inactive state. As shown in FIGS. 1 and 4A-4B, the actuator 80 may be in the form of a button included by the handle 70 that is configured to be manually actuated by the user. Additionally or alternatively, the actuator 80 may be in the form of a sensor (not shown) included by the handle 70 that is configured to detect a shaving action, or lack thereof, and/or a contact, or lack thereof, between the head 20 and the skin of the user during a shaving action, thereby automatically prompting the electronic control unit to transition the magnetic field module 50a, 50b from the inactive state to the active state and/or to transition the magnetic field module 50a, 50b from the active state to the inactive state, respectively. It is contemplated that the sensor may be any type of sensor that may be compatible with the shaving device 10, such as a pressure sensor, force sensor, accelerometer, gyroscope, magnetometer, proximity sensor, and/or the like.

As illustrated by FIGS. 2-4B, in operation, the user grasps the shaving device 10 to perform a shaving action, such that the actuator 80 is actuated manually or automatically, thereby prompting the electronic control unit to transition the magnetic field module 50a, 50b from the inactive state to the active state. During the active state of the magnetic field module 50a, 50b, the magnetic field module generates the magnetic field, which interacts with the plurality of projections 30, thereby moving the plurality of projections 30 (see FIG. 3). Movement of the plurality of projections 30 allows the plurality of projections 30 to exfoliate the skin of the user during contact between the plurality of projections 30 and the skin of the user, prior to and/or during contact between the skin of the user and the plurality of blades 28 of the shaving device 10, during performance of a shaving action by the user. In this manner, the shaving device 10 is configured to exfoliate the skin of the user without requiring a separate tool, treatment, and/or performance of a specific exfoliating action. When the user is finished performing a shaving action, the user actuates the actuator manually or automatically, thereby prompting the electronic control unit to transition the magnetic field module 50a, 50b from the active state to the inactive state. During the inactive state of the magnetic field module 50a, 50b, the magnetic field module 50a, 50b no longer generates the magnetic field, thereby returning the plurality of projections 30 to rest (see FIG. 2).

Although the present disclosure herein has been described with reference to particular embodiments, it is to be understood that these embodiments are merely illustrative of the principles and applications of the present disclosure.

It is intended that the specification and examples be considered as exemplary only, with a true scope of the disclosure being indicated by the following claims.

Additionally, all of the disclosed features of an apparatus may be transposed, alone or in combination, to a method and vice versa.

1. A shaving device comprising:
a head extending between a first end and a second end, the head being configured to support a blade, and the head comprising a base extending between the first end of the head and the second end of the head, the base including one or more magnetic projection extending from a surface of the base being configured to face a shaving surface;
a handle being configured to support the head; and
a magnetic field module included by one of the handle or the head, the magnetic field module being configured to be transitioned between an inactive state and an active state;
wherein the magnetic field module is configured to interact with the one or more magnetic projection in the active state to move the one or more magnetic projection.

2. The shaving device according to claim 1, wherein the magnetic field module is included within the handle of the shaving device.

3. The shaving device according to claim 1, wherein the one or more magnetic projection comprises a flexible stem extending from a root attached to the surface of the base of the head to a tip.

4. The shaving device according to claim 1, wherein at least a portion of the one or more magnetic projection is comprised of one or more ferromagnetic element suspended in an elastomeric matrix.

5. The shaving device according to claim 1, wherein the one or more magnetic projection has a mean diameter within a range of 0.001 mm and 0.5 mm.

6. The shaving device according to claim 1, wherein the one or more magnetic projection extends to a mean length within a range of 0.001 mm and 1 mm.

7. The shaving device according to claim 1, wherein the one or more magnetic projection is configured to move at a frequency of 10 Hz to 200 Hz.

8. The shaving device according to claim 1, wherein the magnetic field module comprises one or more conductor configured to generate a magnetic field capable of interacting with the one or more magnetic projection.

9. The shaving device according to claim 1, wherein the magnetic field module comprises one or more field magnet configured to generate a magnetic field capable of interacting with the one or more magnetic projection.

10. The shaving device according to claim 1, comprising a plurality of magnetic projections extending from the base of the head.

11. The shaving device according to claim 10, wherein the plurality of magnetic projections are included in a plurality of sections of the base of the head, and one or more section of the plurality of sections is included within a recess defined by the base of the head.

12. The shaving device according to claim 10, wherein each magnetic projection is located at a mean distance within a range of 0.05 mm and 2 mm from an adjacent magnetic projection.

13. The shaving device according to claim 1, wherein the handle includes an actuator configured to transition the magnetic field module between the inactive state and the active state.

14. The shaving device according to claim 13, wherein the actuator is configured to be actuated manually by a user.

15. The shaving device according to claim 14 wherein the actuator is in the form of a sensor and is configured to detect a shaving action between the head and the skin of a user.

16. The shaving device according to claim 15 wherein the sensor is one of a pressure sensor, force sensor, accelerometer, gyroscope, magnetometer, proximity sensor.

17. A method of exfoliating a surface of a user during a shaving action, the method comprising:
providing the shaving device according to claim 1;
transitioning the magnetic field module from the inactive state to the active state; and
pressing the one or more magnetic projection against the surface of the user.
